(19) United States
(12) Patent Application Publication
(10) Pub. No.: US 2017/0154161 A1
(43) Pub. Date: Jun. 1, 2017

(54) CLIENT MONITORING, MANAGEMENT, COMMUNICATION, AND PERFORMANCE SYSTEM AND METHOD OF USE

(71) Applicant: In Hand Health, LLC, Shawnee, KS (US)

(72) Inventors: Michael J. Gassman, Kansas City, MO (US); Jeffrey S. Clary, Overland Park, KS (US); Stephanie M. Nicholson, Leawood, KS (US); Christopher W. Maloney, Overland Park, KS (US)

(73) Assignee: In Hand Health, LLC, Shawnee, KS (US)

(21) Appl. No.: 15/365,560

(22) Filed: Nov. 30, 2016

Related U.S. Application Data
(60) Provisional application No. 62/261,099, filed on Nov. 30, 2015.

(51) Int. Cl. G06F 19/00; G06F 21/62; H04L 29/06

(52) U.S. Cl. CPC G06F 19/3418; H04L 67/42; G06F 21/6245; G06F 19/3406; G06F 19/325; G06F 19/3456; G06F 19/3481

(57) ABSTRACT

A communication, analysis, and treatment system including a computer system having a computing device associated with a specialist professional (e.g. a physical therapist) and a mobile computing device associated with a client (e.g. a patient). A remote server and database stores the software associated with the present invention. The specialist is able to quickly view a dashboard containing a brief description and status of all of the specialist's clients. In the example of a physical therapist, this would include all of the therapist's patients. Client data is organized into episodes, such as injury events. Prescriptions are assigned by the specialist to respond to these episodes. Access to this data is strictly restricted for confidentiality.

### CROSS-REFERENCE TO RELATED APPLICATION

This application claims the benefit of U.S. Provisional Patent Application No. 62/261,099, filed Nov. 30, 2015, which is incorporated herein by reference.

### BACKGROUND OF THE INVENTION

1. Field of the Invention

The present invention relates generally to a patient recovery management system and method of use thereof, and more specifically to a computer software communication tool for use between a patient or client and a physician, physical therapist, trainer, or other specialist for monitoring patient/client progress and/or recovery, providing communication between the parties, and creating and assigning prescriptions for exercises or other tasks.

2. Description of the Related Art

Physical therapists, physicians, personal trainers, and other specialists typically do much for their patients and clients during routine visits to the specialist's office. However, the time between patient or client visits is typically impossible for the specialist to monitor. Coincidentally, this time between the visits is the most crucial to patient or client recovery or progression. Many patients or clients may “fall off the wagon” during these lapses between visits and fail to completely perform tasks requested by them of their specialist, such as performing recovery exercises prescribed by a physical therapist. The reasons for these lapses are many; sometimes the exercises may be difficult for the patient to recall how to properly perform; sometimes the exercise prescription may be extensive and difficult for the patient to recall; and sometimes a lack of motivation or inability to communicate with their specialist leaves the patient or client unwilling or unable to perform their tasks completely or at all.

What is needed is a system which allows these types of specialists to easily monitor their patients and clients between visits, a system for measuring which patients are performing well and which are falling behind, and a means for allowing quick and confidential communication between patients and specialists to overcome any issues between visits.

Heretofore there has not been available a system or method for client management and communication with the advantages and features of the present invention.

### SUMMARY OF THE INVENTION

The present invention generally provides a computer system including a computing device associated with a specialist professional (e.g. a physical therapist) and a mobile computing device associated with a client (e.g. a patient). A remote server and database stores the software associated with the present invention. The specialist is able to quickly view a dashboard containing a brief description and status of all of the specialist's clients. In the example of a physical therapist, this would include all of the therapist's patients.

Each of the therapist's patients will be color-coded and could be sorted by a Calculated Rehabilitation Index, or “CaRe Index,” which is calculated using a weighted algorithm including data provided by the patient, data provided by the therapist, and data calculated by the server. The therapist can quickly determine which patients are having issues and why, and can evaluate which patients need immediate feedback or help.

The software system allows the therapist to generate exercise prescriptions for each of their patients. These prescriptions may include exercises loaded from prescription templates, or may be customized as the therapist deems necessary. Each prescription is then sent to the patient in the form of instructional videos which may be accessed by the patient via their mobile computing device. If each of the videos is watched in full, it is accepted that during that time, the patient has conformed with the task assigned by the therapist, and the CaRe Index is adjusted accordingly. The patient then provides feedback after the prescription is completed as to how they physically are feeling. This further adjusts the index. Notes or other information input by the therapist further adjusts the index.

HIPAA-secure therapist-to-patient messaging is provided alongside the dashboard. If a patient would like to communicate with the therapist or vise-versa, the two parties can do so using text, sound-clips, video-clips, photographs or a combination thereof. All of this communication is protected as required by HIPAA standards. Video-clips may be useful to verify that the patient is performing each exercise correctly. This further allows the therapist to check in on patients who are trending downward on the CaRe index between office visits.

### BRIEF DESCRIPTION OF THE DRAWINGS

The drawings constitute a part of this specification and include exemplary embodiments of the present invention illustrating various objects and features thereof.

FIG. 1 is a block diagram depicting the relationship between many elements of the present invention.

FIG. 2 is another block diagram depicting the relationship between other elements of the present invention.

FIG. 3 is a diagram depicting an example dashboard user interface (UI) of a specialist's computing device embodying elements of an embodiment of the present invention.

FIG. 4 is a diagram depicting an example protocol library user interface (UI) of a specialist's computing device embodying elements of an embodiment of the present invention.

FIG. 5 is a diagram depicting an example performance template user interface (UI) of a specialist's computing device embodying elements of an embodiment of the present invention.

FIG. 6 is a diagram depicting an example selected performance template user interface (UI) of a specialist's computing device embodying elements of an embodiment of the present invention.

FIG. 7 is a continuation of the diagram of FIG. 6.

FIG. 8 is a diagram depicting an example client description “at a glance” tab user interface (UI) of a specialist's computing device embodying elements of an embodiment of the present invention.

FIG. 9 is a diagram depicting an example an example client description “charts” tab user interface (UI) of a specialist's computing device embodying elements of an embodiment of the present invention.

FIG. 10A is a diagram depicting an example home screen user interface (UI) of a client's mobile computing device.

FIG. 10B is a diagram depicting an example menu user interface (UI) of a client's mobile computing device.

FIG. 10C is a diagram depicting an example charts user interface (UI) of a client's mobile computing device.

FIG. 10D is a diagram depicting an example instructions and exercises user interface (UI) of a client's mobile computing device.

FIG. 10E is a diagram depicting an example instructional video user interface (UI) of a client's mobile computing device.

FIG. 11A is a diagram depicting an example clients list user interface (UI) of a specialist's mobile computing device.

FIG. 11B is a diagram depicting an example exercises list user interface (UI) of a specialist's mobile computing device.

FIG. 11C is a diagram depicting an example exercise menu user interface (UI) of a specialist's mobile computing device.

FIG. 12A is a flowchart diagramming steps taken to practice an embodiment of the present invention.

FIG. 12B is a continuation thereof.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning. Additional examples include computing devices such as a mobile smart device including a display device for viewing a typical web browser or user interface will be commonly referred to throughout the following description. The type of device, computer, display, or user interface may vary when practicing an embodiment of the present invention. A computing device could be represented by a desktop personal computer, a laptop computer, “smart” mobile phones, PDAs, tablets, or other handheld computing devices.

While a preferred embodiment of the present invention focuses on a system usable between a physical therapist and their patients, the present invention could be utilized in any service industry where a specialist would benefit from following up on a daily basis with their clients, such as (but not limited to) medical doctors, occupational therapists, social workers, and personal trainers.

### II. Preferred Embodiment Client and Specialist Management and Communication System 2

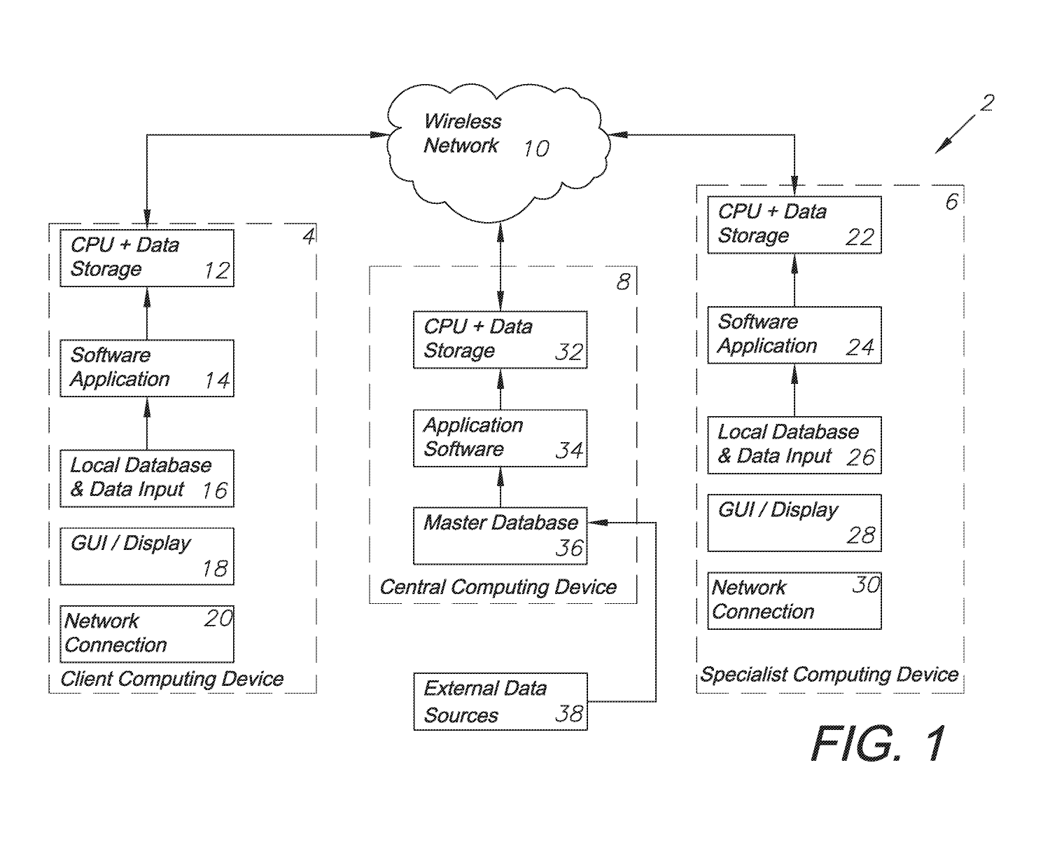

Referring to the figures in more detail, FIG. 1 shows a preferred embodiment of a client and specialist management and communication system 2. A primary example of such as system would be one where the client is a patient and the specialist is a physical therapist or other medical professional, however the present invention could be used for any client-specialist communication and management relationship.

In detail, FIG. 1 shows the primary components of the management and communication system 2, including a client mobile computing device 4, a specialist computing device 6, a central computing device server 8, and a wireless communications network 10, such as the internet.

The client computing device 4 would typically be a smartphone, tablet, or personal computer. The device itself includes a CPU and data storage 12 storing and running a software application 14 for accessing the management and communication system. A database and data input 16 stored on and input into the computing device 4 is accessible with the software application 14. A graphical user interface (GUI) display 18 allows the user to interact with the software application. A network connection 20, such as an antenna, allows the device to access the wireless network 10.

Similarly, the specialist's computing device 6 would typically be a smartphone, tablet, or personal computer: typically both a mobile smart phone and a stationary desktop computer. The device itself includes a CPU and data storage 22 storing and running a software application 24 for accessing the management and communication system. A database and data input 26 stored on and input into the computing device 6 is accessible with the software application 24. A graphical user interface (GUI) display 28 allows the user to interact with the software application. A network connection 30, such as an antenna, allows the device to access the wireless network 10.

The central computing device 8, or central server, stores the core software, databases, and processing components for the management and communication system 8. It stores the software applications that the clients and specialists must download to access the various data pertinent to the present invention. The central server therefore includes a CPU and data storage 32, application software 34, and a master database 36. The central server may also be connected to external data sources 38, either through the wireless network 10 or otherwise.

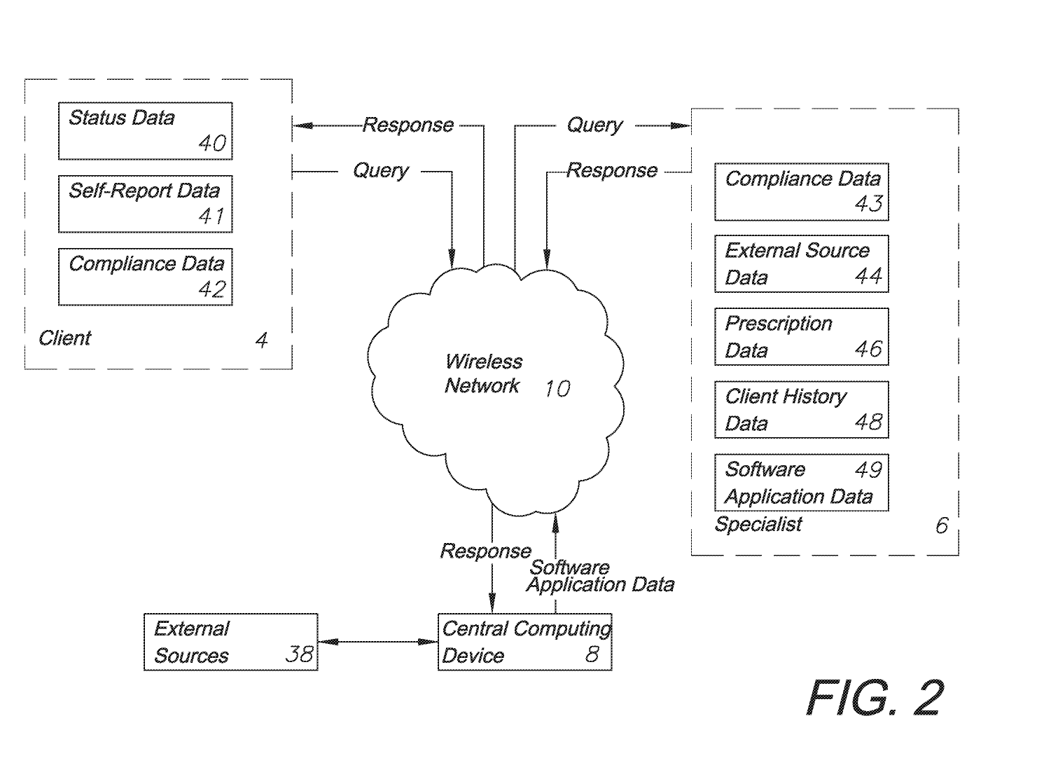

FIG. 2 shows further interactions of data between the client device 4, the specialist device 6, and the central computing device 8 via the wireless network 10. The client device 4 stores client status data 40, self-reporting data 41, and compliance data 42. That data is sent via queries from the client's device, and responses can be sent back from the specialist's device 6. The compliance data 42 from the client device is transformed into compliance data 43 stored in the specialist's computing device, along with external source data 44, prescription data 46, client history data 48, and software application data 49.

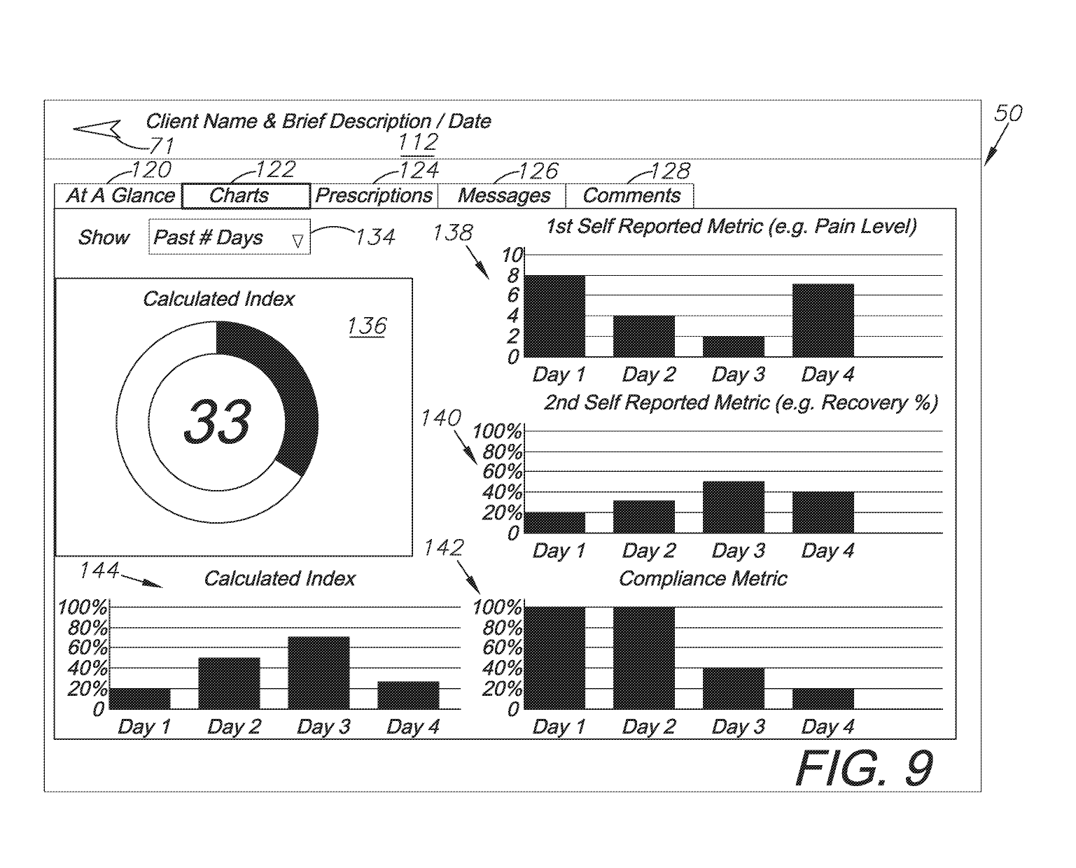

In the example of a client-specialist relationship wherein the client is a patient and the specialist is a physical therapist, the client/patient will receive prescriptions including exercises to be performed. These will be prescribed by the specialist/therapist, and assigned via the software application. These prescriptions will include videos of exercises being performed, a set number of sets and repetitions for each exercise to be performed, and other instructional information. The client/patient will self-report several criteria each day, including pain level and level of recovery. His is the self-reported data 41. Compliance data 42 will be automatically collected as the patients confirm that the exercises have been performed. This data is sent to the specialist/therapist, and is turned into a calculated index 136 (see FIG. 9) which provides the specialist an at-a-glance view of the client's progress.

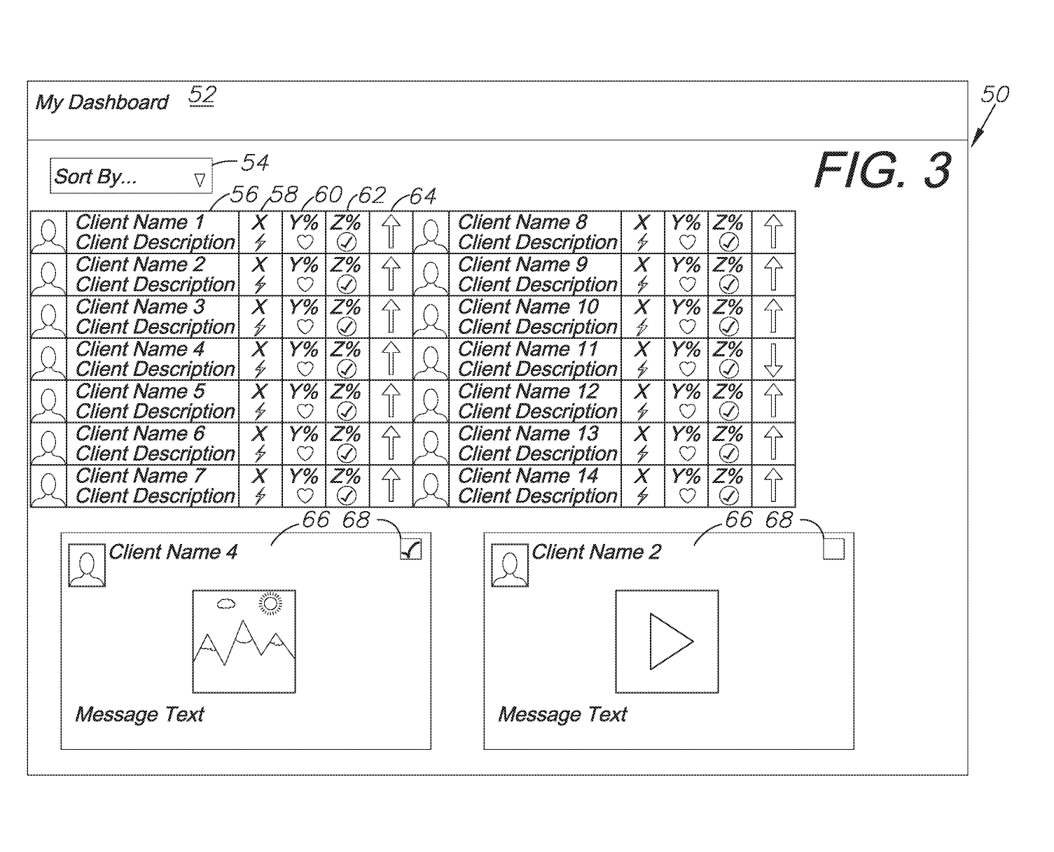

FIG. 3 shows an example user interface of a dashboard 52 associated with the software application 24 of the specialist as contained within a browser window 50, such as would be viewable on a personal computer. Here, a list of the specialists' clients can be seen at a glance, along with basic information on each client. Each client has a client photograph and client name 56 along with a brief description of the client's purpose for seeing the specialist (e.g. in the patient/therapist example, the patient's injury). Three data points are shown, such as a self-reported 1-10 pain level 58, a 1-100% level of recovery 60, and a 1-100% level of compliance 62 which is automatically calculated if the patient/client performs the prescribed exercises in that example. An arrow 64 indicates if the client is trending upwards or downwards from day-to-day. Each client bar would also be color-coordinated according with the calculated index 136, which is derived from the three data points 58, 60, 62 indicated above. The specialist can use a dropdown menu 54 to sort the list of patients as desired, such as by data point, calculated index value, or other.

Also shown on the dashboard are messages 66 sent from clients to the specialist. An indicator 68 shows if the message has been viewed or not. The messages could include photographs or videos, such as photos or videos of the patient performing exercises in accordance with an assigned prescription from the specialist.

In a preferred embodiment of the present invention, such as an example situation where the professional is a physical therapist and the client is a patient, only those therapists assigned to a particular patient will have access to the patient's information, messages, and past and present episode data. Each patient's condition is divided into a separate episode, and is treated by prescriptions comprising multiple performances (e.g. exercises) as described in more detail below. All of this data is stored on the central computing device 8, and is kept completely confidential. In the case of a medical office or physical therapist clinic, this means all communications, prescriptions, and performance history are kept HIPAA compliant. Only notifications are sent to the client's mobile computing device 4 to indicate that new prescriptions or exercises are available for view.

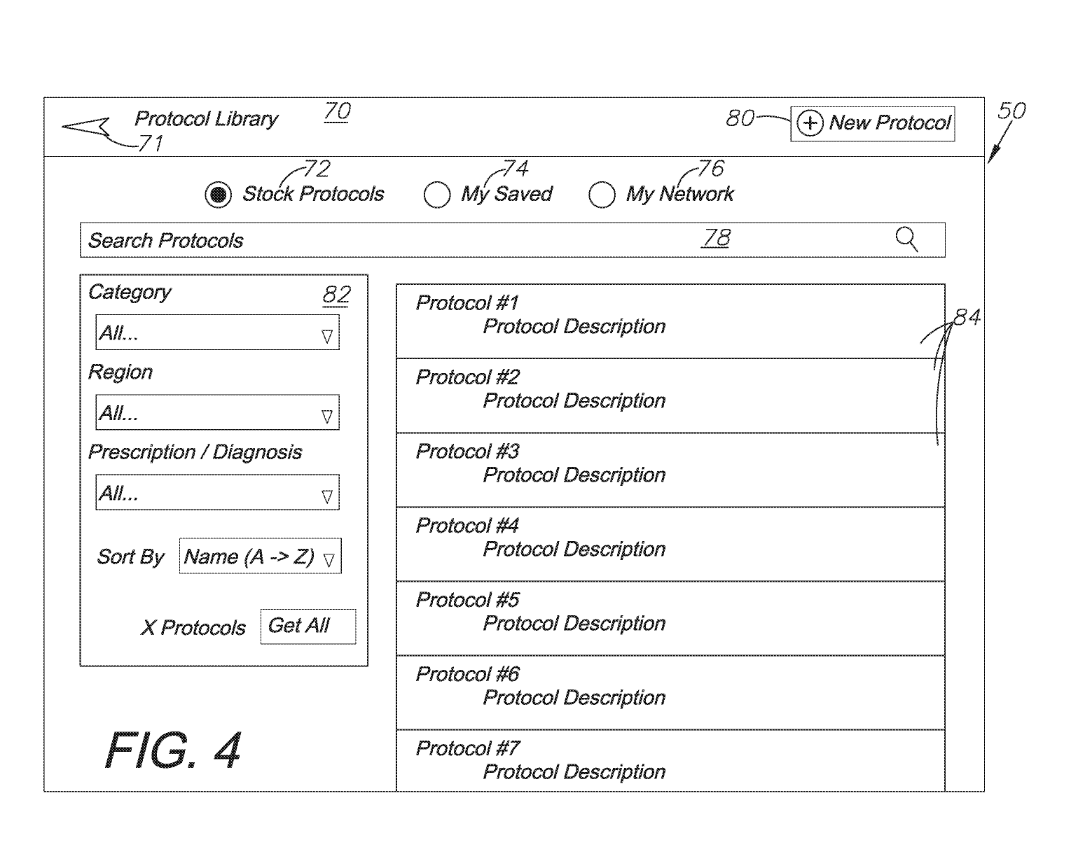

FIG. 4 shows a protocol library 70 user interface, which would be accessed from the dashboard 52. A back button 71 would allow the specialist to return to a previous menu or interface. In the example of a patient/client and therapist/specialist, the protocols 84 would be sets of exercise aimed at physical therapy recovery for a specific injury or post-surgery rehabilitation. New protocols can be added by the specialist at any time by accessing the new protocol button 80. There, the specialist can lump together exercises into new protocols. The specialist can browse stock protocols 72, such as those provided from the central server 8, the specialists' own saved protocols 74 which they have created, or a local network of protocols 76, such as those created by other therapists in the specialist's practice group. The protocols can be searched in the search bar 78, such as by exercise or diagnosis, or they can be sorted by category, region, etc. as identified in the sorting menu 82. Protocols are a suggested series of performances (e.g. exercises) intended for treating a particular situation or diagnoses. These protocols can be broken up into multiple steps or phases as treatment progresses. These are intended to be long-term plans for patient recovery or generalized client treatment.

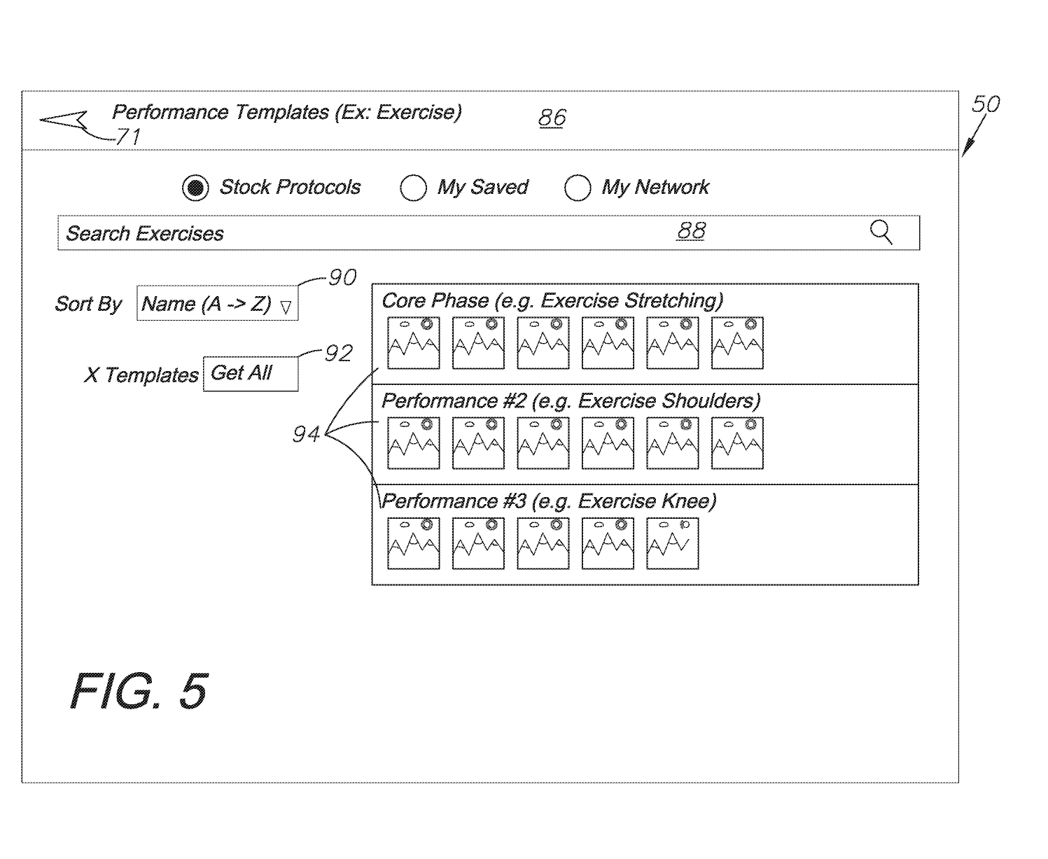

FIG. 5 shows a performance templates interface 86 which provides access to performances 94, such as exercises, which can be grouped together into templates 86. Individual exercises or exercise templates can then further be grouped into the protocols indicated above and shown in FIG. 4. Another search bar 88 allows for searching through the exercises, or they can be sorted by the dropdown sort menu 90 or all may be shown using the “get all” button 92. These templates 94 include the name of the template, such as what is being targeted, and may include many photographs of steps of performing the various exercises.

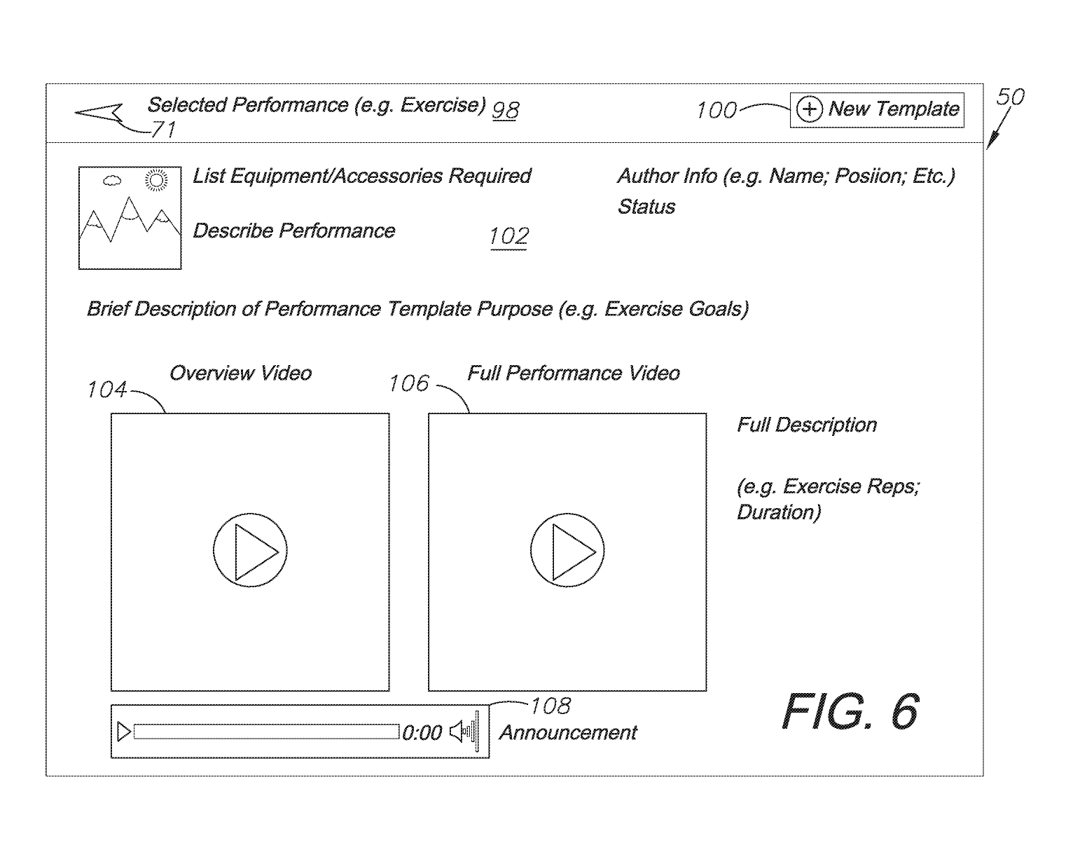

FIG. 6 shows an individually selected performance user interface 98, which can be accessed by selecting a template from the previous interface shown in FIG. 5. These performances typically include exercises to be performed by the client. New performances (e.g. exercises) or performance templates can be created at this stage using the new template button 100. The selected performance has an overview photo along with information 102 about the template, such as the author, the status, and a detailed description of the exercise(s) involved in the performance. An overview video 104 is accessible, which gives a brief overview of how the exercise is performed and what it does. An actual performance video 106 provides a full performance of the exercise, showing a person physically going through the exercise in real time with voice-over commands. An audio announcement 108 could also be located here to provide additional information or feedback to clients.

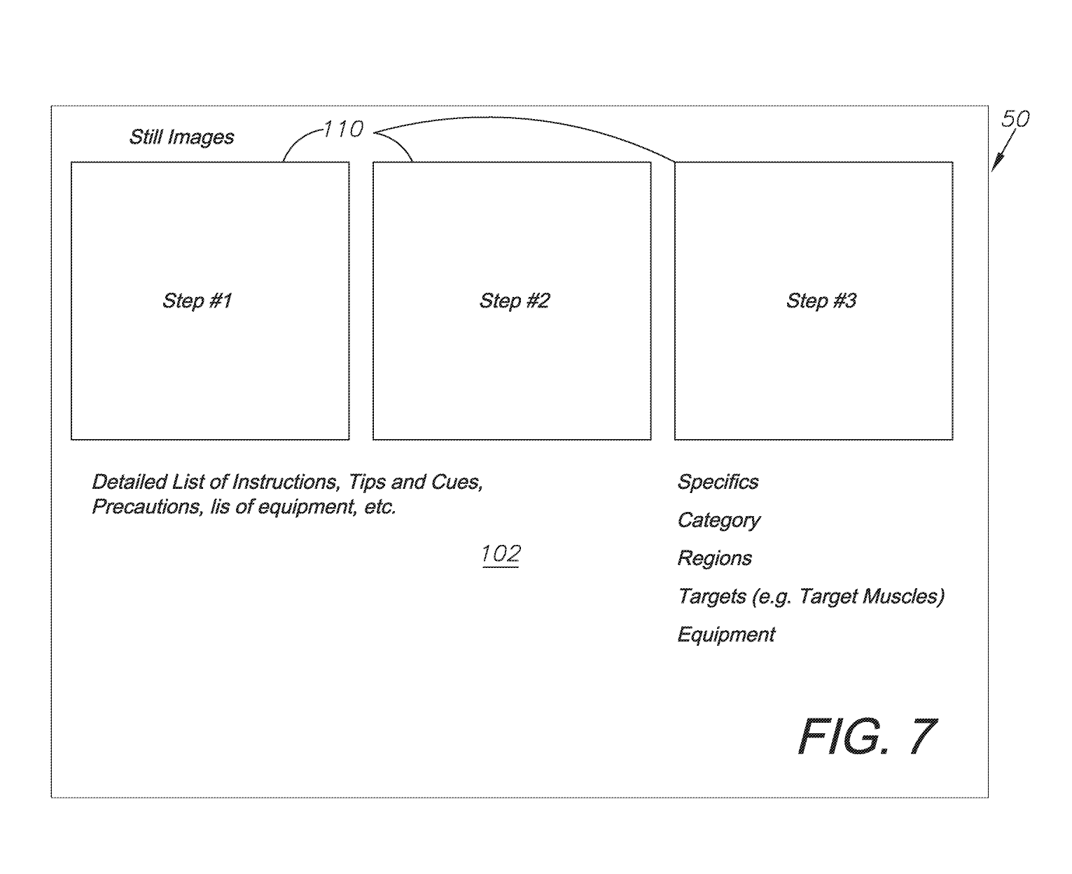

FIG. 7 continues the selected performance template user interface 98 from FIG. 6. Here, still images 110 of the steps of the exercise can be shown, along with more information 102 of the exercise, such as the category that the exercise is listed under, what region it is targeting, and whether any equipment is needed to perform the exercise.

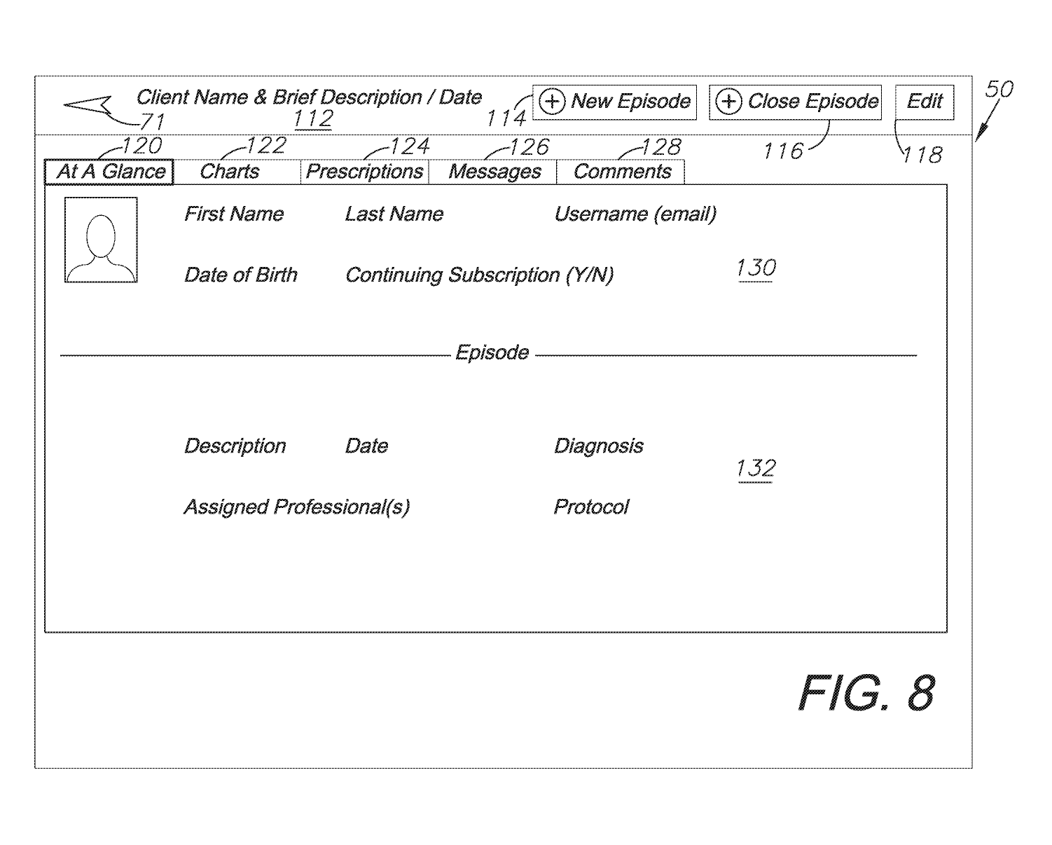

FIG. 8 shows a client information user interface 112, which includes several tabs for different pieces of information, including an at a glance tab 120 for providing basic patient information 130 and episode information 132. Other tabs include a charts tab 122 shown in FIG. 9, a prescriptions tab 124 which may contain a list of prescriptions prescribed to this client, a messages tab 126 which will show any messages from or to this client, and a comments tab 128 for providing a comments section for the specialist to use. On the at a glance tab 120, the specialist can also choose to create a new episode 114 for the client or to close the existing episode 116 of the client, or even to edit 118 the current episode. In the example of a patient/client and a physical therapist/specialist, these episodes would likely be client visits for individual injury or surgery rehabilitation events. In a preferred embodiment of the present invention, the data shown here links to past and current episodes associated with the client, which can be accessed by the professional at any time. These episodes lead to past protocol assignments.

The charts tab 122 of the client information user interface 112 includes a calculated index 136 which is calculated based upon the data indicated previously both reported by the client and automatically generated based on compliance of the client. The calculated index 136 is displayed with a number and a graphical indicator of the result. The result would also be color coordinated. In the example of the patient/client, the higher the calculated index 136, the better recovered the patient and the less likely the specialist needs to follow up with that patient/client.

In a preferred embodiment, higher-valued calculated indexes would be green, with other colors such as yellow, orange, and then red indicating declining indexes. The colors of the calculated index 136 depend on the number shown in FIG. 9, and the client's bar shown in FIG. 3 would have a matching color, with the trend arrow 64 indicating if the client's calculated index is rising or declining over a set period of time.

The calculated index 136 and other charts on the charts tab 122 can be sorted based on a past number of days, weeks, months, etc. using the sort menu 134. Other charts shown on this tab include the first self-reported client metric chart 138 (e.g. patient pain levels), the second self-reported client metric chart 140 (e.g. patient recovery percentage), the compliance metric chart 142 (e.g. patient exercise performance), and past calculated index value chart 144.

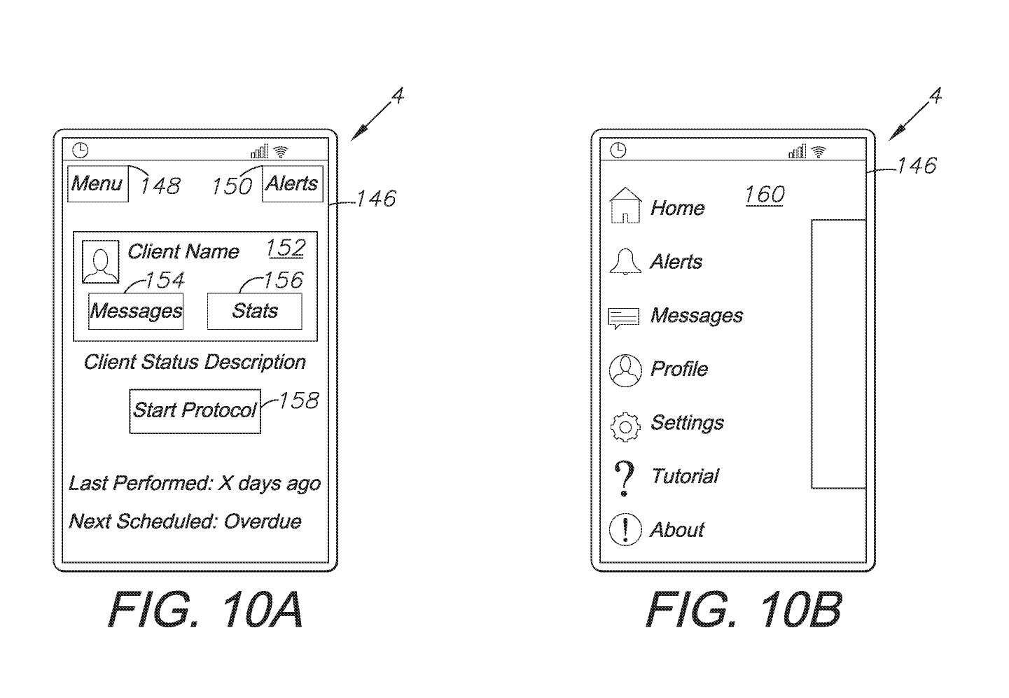

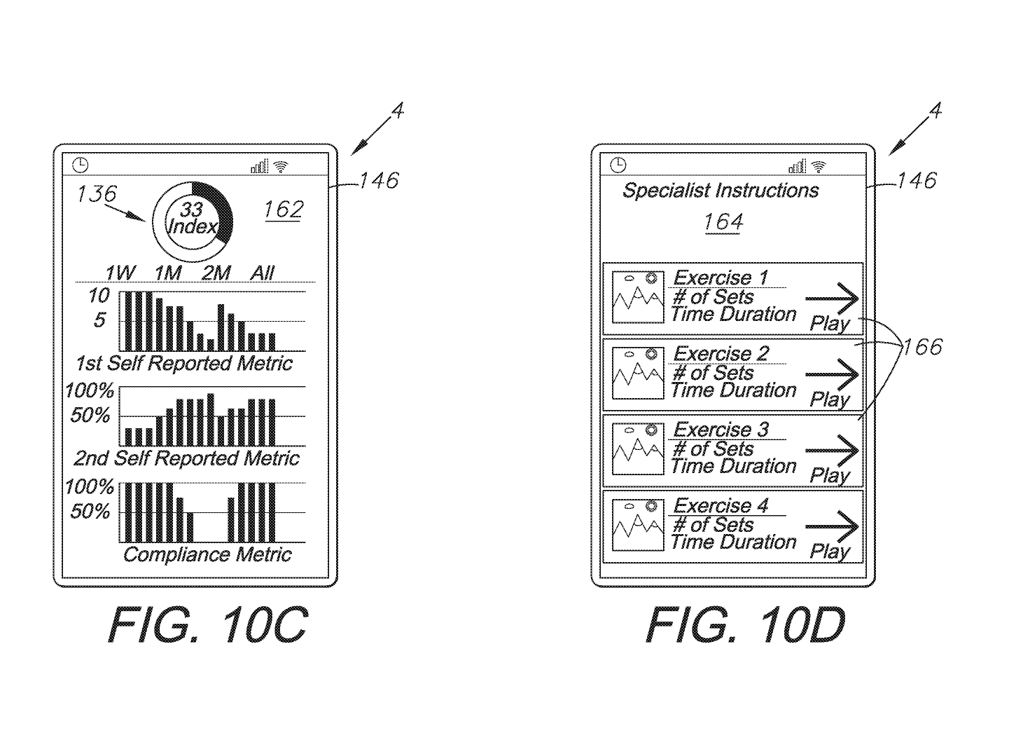

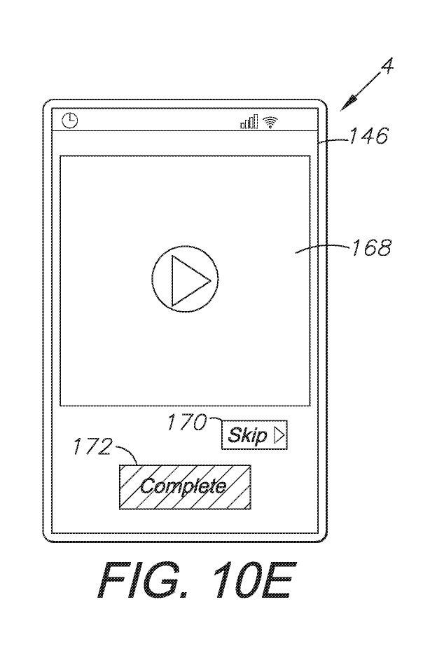

FIGS. 10A-10E show a graphical user interface 146 of a client's mobile computing device 4, which in a preferred embodiment would be a smartphone or tablet computing device.

FIG. 10A shows a home screen user interface with a client information window 152 identifying the client's name and optionally including a photograph of the client. Links to view messages 154 and statistics 156, such as the calculated index or other charts, are located prominently for easy access. Other links to a main menu 148 and alerts 150 are also available. Another link to begin the prescribed protocol 158 is also provided, which will take the user to a prescribed protocol (e.g. exercises). Other information, such as when the last protocol was performed or when the next protocol is due may be shown as well.

FIG. 10B shows a basic menu screen 160, which has links to many of the other portions of the software application on the client's mobile computing device 4.

FIG. 10C shows a charts screen 162 similar to the interface under the charts tab 122 shown in FIG. 9. The calculated index 136 along with the other chart data can be shown here.

FIG. 10D shows an instructions screen 164 containing assigned exercises 166 from the client's specialist. These exercise links take the client to FIG. 10E which contains a video 168 of the exercise, an optional button to skip 170 the video, and a “complete” button 172 the user may activate only once the video has played completely. This is directly linked to the compliance data 42 sent from the client's mobile computing device 4 to the central server 8 and the specialist 6. This ensures the client fully views (and hopefully performs) the task shown in the video, such as in an exercise video for physical therapy recovery.

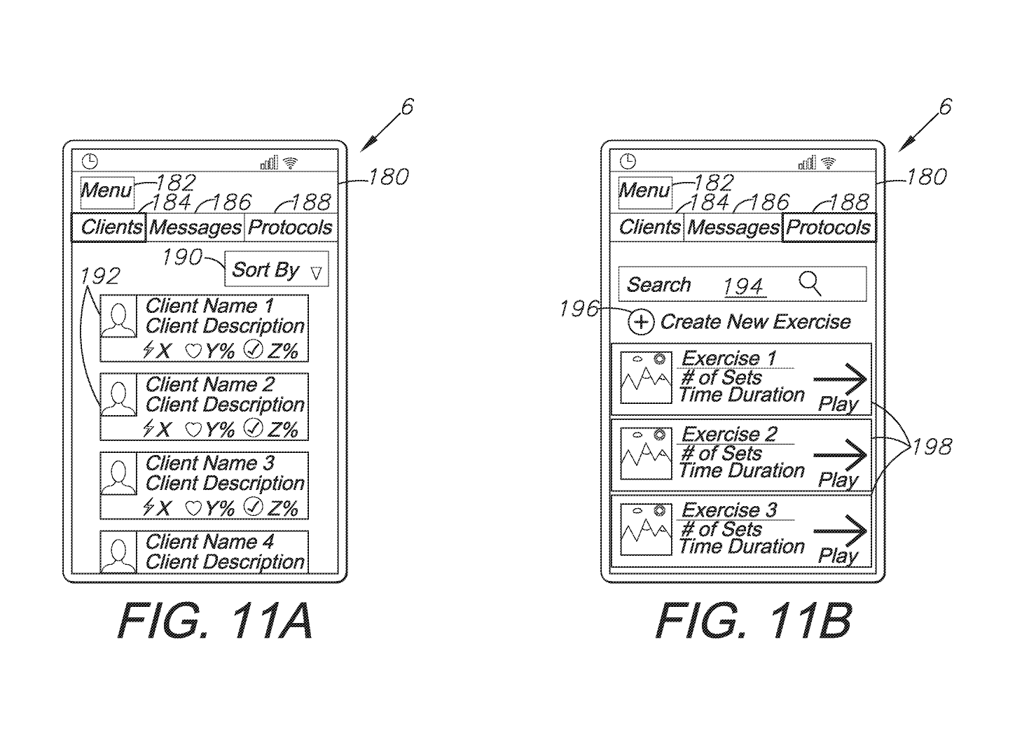

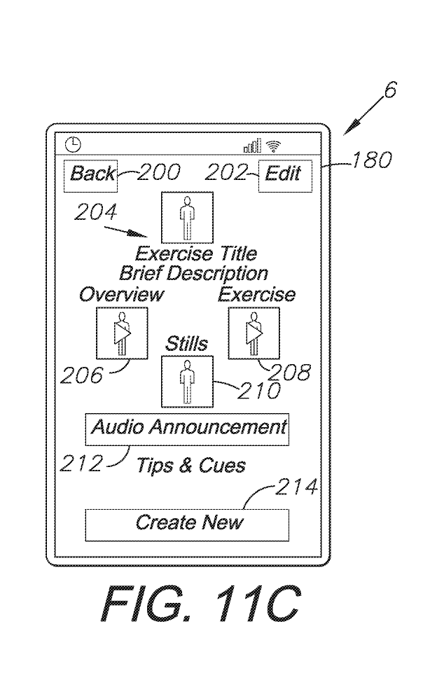

FIGS. 11A-11C similarly show a user interface 180 for a specialist's mobile computing device 6, which in a preferred embodiment would be a smartphone or tablet computing device. FIG. 11A shows a list of clients 192, with a quick-display of client names, photographs, and status. The specialist can sort the list of clients using the sort dropdown menu 190. The specialist can access a basic home menu using the button 182, or can select between a clients tab 184, a messages tab 186, and a protocols tab 188 as necessary. Each tab shows different information. FIG. 11A shows the clients tab 184.

FIG. 11B shows the protocols tab 188. This tab shows a list of exercise sets 198 or other protocols which the specialist can view, edit, and assign to clients. The specialist can also create new exercises 196 using onboard components of the smartphone device 6, such as the camera and microphone. The specialist can use the search bar 194 to search for specific exercises or other protocols as well.

FIG. 11C is a view showing a selected exercise protocol 204, including a thumbnail photograph identifying the exercise, along with a brief description and title. An overview video 206 is accessible here, along with an actual exercise video 208 and photo stills 210 of the exercise. The overview video 206 provides information about the exercise, what its purpose is for, and how it is performed. The exercise video 208 actually shows the exercise being performed for a prescribed number of repetitions. An audio announcement 212 may also be included, along with other tips and cues, which may be customized for each individual client and contain more information. The specialist can back out of this screen using a back button 200, edit the exercise protocol with an edit button 202, or create a new protocol exercise with the create new button 214.

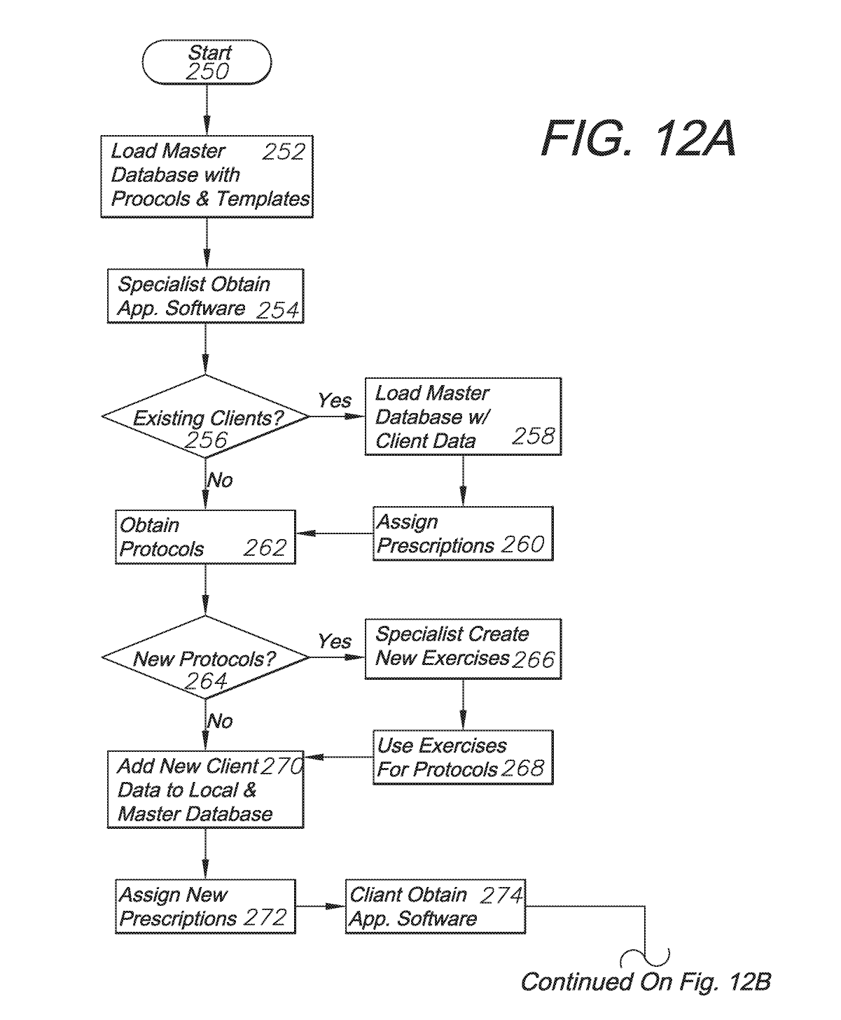

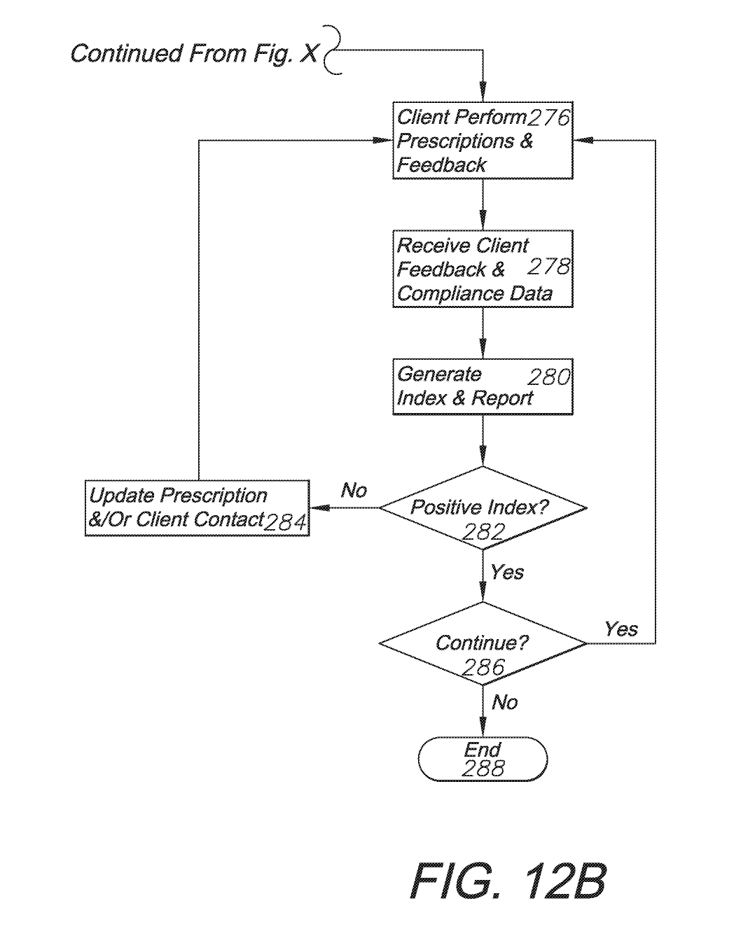

FIGS. 12A-12B step through the process by which an embodiment of the present invention may be practiced. These steps begin at 250, after which the core master database 36 is loaded with at least some initial protocols and templates, such as the exercises and protocol templates 252 discussed above. These will form the backbone of the prescriptions which specialists can prescribe to clients until new exercises or prescriptions are created by the specialists themselves, which may be available to other specialists depending on circumstances such as client confidentiality.

Next, the specialist(s) obtains the application software at 254, whereby they download the software to their mobile computing device 6 or their personal computer, or access the software remotely using a standard internet web browser. A check occurs at 256 to determine if the specialist has existing clients whom they wish to add to the database. If yes, the master database is loaded with their client data at 258 and prescriptions that have been prescribed to those clients are assigned using the software at 260. After which the specialist obtains protocols at 262 from the master database using the software application.

The specialist can determine if new protocols should be made at 264. If yes, the specialist will create new exercises or other protocol elements at 266 as described previously. After this, these exercises and other elements are compiled into protocols at 268 which can be prescribed for clients by the specialist.

Any new clients can then be added to the local and master databases at 270, and those new clients need to have prescriptions assigned at 272. These new clients could also be existing clients requiring a new episode (e.g. new injury event for physical therapist).

All clients should then obtain the application software at 274 for receiving prescriptions from the specialist and performing the exercises, while also providing the data necessary to calculate the calculated index, allowing the specialist to monitor the client without having to have daily interaction.

Continued on FIG. 12B, the client will perform the prescriptions and provide the feedback data at 276. This leads to the calculation of the calculated index which gives the specialist information on the client's progress (e.g. recovery). The specialist and the central server receive the client feedback and compliance data at 278 and generate the index at 280, resulting in information the specialist can use to evaluate the client's status. The specialist will track the calculated index and determine at 282 if there is a positive index. If not, the specialist may opt to update the prescription and/or schedule a meeting with the client at 284 to determine what's going wrong. Otherwise, if the index is positive, the specialist will determine at 286 whether to continue the prescriptions with the client or to end the process at 288.

The present invention is not meant to be a single-pass practice, and so the example shown in FIGS. 12A and 12B are merely one example of one part of how the present invention could be practiced. In a preferred embodiment, these steps continue indefinitely as treatment is required (e.g. for a physical therapy patient).

Another important feature of the present invention is to collect data on the effectiveness of the protocols 84 and performances 94 (e.g. exercises). Data is collected from the client's self-report data 41 and compliance data 42 to indicate the effectiveness of the protocols and individual performances. As this data is collected, it can be determined how effective these protocols and performances are for treating specific episodes. This can then be used to provide feedback for other professionals looking to prescribe these protocols and performances for their own treatment prescriptions.

It should be noted that while the client computing device 4 does not necessarily include a camera and/or microphone, those features are commonly included in mobile computing devices and can provide additional features for the client to communicate with the specialist. For example, the client may take a video of themselves performing an exercise for treatment as part of a physical therapy prescription, and can message that video recording to the specialist for review. Similarly, the specialist's computing device 6 may also include a camera and microphone for recording new exercises of themselves or others for creating new protocols, as indicated above and at FIGS. 6 and 11C.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A communication system comprising:
a central server, a first computing device, and a second computing device, each including a respective CPU, data storage, graphical user interface (GUI), and a connection to a computer network;
said first computing device associated with a specialist;
said second computing device including a microphone and a video camera;
said second computing device associated with a client;
a prescription generated by said first computing device, said prescription comprising at least one exercise including a performance video;
said prescription sent from said first computing device through said computer network to said central server, said prescription assigned to an episode associated with said second computing device;
a notification sent from said central server through said computer network to said second computing device indicating said prescription has been received at said central server;
said prescription and said performance video configured to be accessible and viewable with said second computing device, thereby indicating completion of said at least one exercise;
compliance feedback data generated with said central server based upon completion of said at least one exercise;
reporting data generated with said second computing device, wherein said reporting data comprises a selected value amongst a predetermined range;
said reporting data sent from said second computing device to said central server;
a calculated index value calculated from said central server from said compliance feedback data and said reporting data, said calculated index further adjusted based upon frequency of data received from said second computing device;
said calculated index value comprising a numeric value on a scale from zero to one hundred; and
said calculated index value accessible with said first computing device.

2. The system of claim 1, further comprising:
wherein said episode comprises a treatment problem associated with a physical ailment of said client; and
wherein said prescription comprises at least one physical exercise configured to treat said treatment problem.

3. The system of claim 2, further comprising:
wherein a performance video of said physical exercise is recorded from said video camera of said first computing device as a recorded performance;
said recorded performance stored on said central server;
notification of said recorded performance sent to said first computing device; and
said recorded performance is viewed on said first computing device.

4. The system of claim 2, further comprising:
said first computing device including a microphone and a video camera;
wherein a performance video of said physical exercise is recorded from said video camera of said first computing device as a recorded performance;
said recorded performance stored on said central server;
notification of said recorded performance sent to said second computing device; and
said recorded performance is viewed on said first computing device.

5. The system of claim 1, further comprising:
wherein said calculated index value is represented by a pre-determined color code based upon the numerical value of said calculated index value.

6. The system of claim 1, further comprising:
said calculated index value stored on said central server;
said calculated index value comparable with previous calculated index values associated with said client stored on said central server; and
said central server configured to determine a trending direction of said calculated index value over time in a positive or negative direction, said trending direction viewable by said first computing device.

7. A computer-implemented communication method of connecting a professional with a client, the method comprising the steps:
accessing a communication system with a first computing device, wherein said first computing device comprises a CPU, data storage, a graphical user interface (GUI), a microphone, and a camera, and wherein said communication system comprises a central server including a CPU, data storage, and a connection to a computer network;
allocating at least one client episode to said first computing device, wherein said at least one client episode comprises client data associated with a single episodic event;
generating, with said first computing device, a prescription stored on said central server, said prescription comprising at least one exercise including a performance video, and said prescription corresponding to said single episodic event;
sending a notification to a second computing device associated with said at least one client episode, wherein said second computing device comprises a CPU, data storage, a graphical user interface (GUI), a microphone, and a camera;
accessing said prescription with said second computing device;
viewing said performance video with said second computing device, thereby generating compliance data at said central server;
generating reporting data with said second computing device, wherein said reporting data comprises a selected value amongst a predetermined range;
sending said reporting data to said central server;
calculating a calculated index value with said central server, said calculated index derived from said compliance feedback data and said reporting data, and said calculated index further adjusted based upon frequency of data received from said second computing device;
assigning a numeric value on a scale from zero to one hundred to said calculated index value; and
accessing said calculated index value with said first computing device.

8. The method of claim 7, wherein:
said first computing device is associated with a medical professional and said second computing device is associated with a patient;
wherein said single episodic event comprises a physical ailment; and
wherein said exercise is a physical exercise configured to treat said physical ailment associated with said single episodic event.

9. The method of claim 8, further comprising the steps:
recording, with said first computing device video camera, said performance video; and
associating said performance video with said exercise.

10. The method of claim 8, wherein said reporting data comprises at least a recovery value on a scale from zero percent to one hundred percent, and a pain value on a scale from zero to ten.

11. The method of claim 7, further comprising the steps:
storing calculated index value on said central server;
comparing said calculated index value with previously calculated index values associated with said single episodic event;
determining a trending direction of said calculated index with central server over time in a positive or negative direction; and
displaying said trending direction on said GUI of said first computing device, wherein said trending direction is represented by an arrow.

12. The method of claim 11, wherein said calculated index value comprises a color based upon the numeric value of said calculated index value.

13. The method of claim 7, further comprising the steps:
generating a message with said second computing device;
sending said message from said second computing device to said central server;
sending a notification from said central server to said first computing device indicating said message has been received; and
viewing said message with said first computing device.

14. The method of claim 13, wherein said message comprises a video message recorded with said video camera of said second computing device.

15. The method of claim 13, wherein said video message comprises a performance of said exercise.
